(19) United States
(12) Patent Application Publication
(10) Pub. No.: US 2003/0012378 A1
(43) Pub. Date: Jan. 16, 2003

(54) Apparatus of conditional-access module, receiving terminal apparatus and method

(76) Inventor: Koji Yura, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/183,577

(22) Filed: Jun. 28, 2002

(30) Foreign Application Priority Data
Jun. 29, 2001 (JP) 2001-200215

(51) Int. Cl. H04N 7/167

(52) U.S. Cl. 380/241

(57) ABSTRACT

A technique is disclosed which, in viewing the digital broadcasting, allows conditional access information to be verified without any waiting time and the security of the conditional access information to be improved. Specifically, when real-time processing for viewing the digital broadcasting is terminated, background processing for verifying the conditional access information is carried out. That is, the waiting time for verification processing is made unnecessary by verifying the conditional access information in the background.

### CROSS-REFERENCE TO RELATED APPLICATIONS

This application is based upon and claims the benefit of priority from the prior Japanese Patent Application No. 2001-200215, filed on Jun. 29, 2001, the entire content of which are incorporated herein by reference.

### BACKGROUND OF THE INVENTION

1. Field of the Invention

The present invention relates to an apparatus of conditional-access module, a receiving terminal apparatus, and method for use with a digital broadcasting system using communication satellites by way of example.

2. Description of the Related Art

In recent years, a digital broadcasting system has begun to spread. The digital broadcasting system has introduced a pay broadcasting system in whole or part. Receiving terminals for the digital broadcasting system have a conditional-access (CA) module built in or attached, which allows reception of broadcasting associated with contract services.

In the pay broadcasting system, scrambled content is transmitted in a transport stream. Also, conditional access information that allows only subscribers' receiving terminals to descramble the scrambled content is likewise transmitted in a transport stream.

Here, the conditional access information includes a scramble key for descrambling the content and contract information which is necessary for using the scramble key. The contract information is an enormous list indicating subscribers to the digital broadcasting and contract services. The contract services include channels or programs for which descrambling is allowed and the periods for which contracts are valid.

The conditional-access module processes the conditional access information in real time to obtain the scramble key on the basis of contract information concerning the corresponding receiving terminal and then descrambles scrambled content with the scramble key to playback the content.

Thus, the conditional access information is essential for access to digital broadcasting. For this reason, it is possible that access may be made falsely to digital broadcasting by forging or altering the conditional access information, particularly the contract information. The existence of the possibility of forgery or alteration deteriorates the security of the conditional access information.

From the point of view of preventing such false access, on the other hand, a method of verifying the conditional access information using a digital signature is considered possible. According to this method, for example, the broadcasting station will broadcast conditional access information with a digital signature on some information contained therein, such as contract information, that is greatly influenced by forgery or alteration. The receiving terminal is permitted to make access to digital broadcasting after the validity of the conditional access information has been confirmed through the digital signature.

However, the verification of a digital signature has a property which is necessary for large calculated amount in comparison with calculated amount of a signal processing the conditional access information or a descrambling the content in real-time. Thus, it is difficult to verify the digital signature in real-time.

Therefore, the method of verifying the conditional access information using a digital signature is technically possible but is not suited to practical use.

As described above, although there is a possibility of forgery or alteration of conditional access information, if the digital signature is generated by the conditional access information, there is no practical means for the conditional-access module to verify the digital signature. The security of the conditional access information will therefore be lowered.

### BRIEF SUMMARY OF THE INVENTION

It is an object of the present invention to provide an apparatus of conditional-access module, a receiving terminal apparatus and method which permit verifying a digital signature generated by conditional access information while descrambling scrambled contents in real-time in view digital broadcasting, thereby enabling improvement in a security of conditional access information.

According to a first aspect there is provided an apparatus of conditional-access module, which is built in or attached to a receiving terminal apparatus for receiving digital broadcast signal containing scrambled program contents and encrypted conditional access information which includes a digital signature generated by part thereof and is used to descramble the program contents under contract, comprising: control means for executing a real-time processing for decrypting/analyzing the conditional access information or a background processing for verifying the digital signature; and control switching means for causing the control means to execute the real-time processing in preference to the background processing and, at the termination of the real-time processing, switching the control means from the real-time processing to the background processing.

Thus, since the digital signature generated by the conditional access information can be verified through the use of background processing, the conditional access information can be verified while descrambling scrambled contents in real-time in viewing digital broadcasting and hence the security of the conditional access information can be improved.

According to a second aspect of the present invention there is provided an apparatus of conditional-access module, which is built in or attached to a receiving terminal apparatus for receiving scrambled program contents and encrypted conditional access information which includes a scramble key for descrambling the program contents, contract information for allowing the scramble key to be used, and a digital signature generated by the contract information and descrambling the program contents using the scramble key, the apparatus of conditional-access module for controlling the descrambling of the program contents on the basis of the decrypted contract information comprising: a control unit configured to execute a real-time processing or a background processing, the real-time processing which includes decrypting the conditional access information inputted from the receiving terminal apparatus, confirming its own contract on the basis of the decrypted contract information, and outputting the decrypted scramble key to the receiving terminal apparatus, and the background processing which includes verifying the decrypted digital signature on the basis of the decrypted contract information and, when the result of verification indicates falsely, outputting a disable signal for disabling the program contents at the receiving terminal apparatus; and a control switching unit configured to cause the control unit to execute the real-time processing in preference to the background processing and, at the termination of the real-time processing, switching the control unit from the real-time processing to the background processing.

In this configuration as well, since the digital signature generated by the conditional access information can be verified through the use of background processing, the conditional-access module according to the second aspect can perform the same function as that of the first aspect.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing the configuration of a receiving terminal to which a conditional-access module is connected according to a first embodiment of the present invention;

FIG. 2 is a schematic diagram showing the configuration of the conditional-access module in the first embodiment;

FIG. 3 is a flowchart illustrating the operation of the control section in the conditional-access module in the first embodiment;

FIG. 4 is a schematic diagram showing the configuration of a receiving terminal according to a second embodiment of the present invention;

FIG. 5 is a schematic diagram showing the configuration of the conditional-access module in the second embodiment;

FIG. 6 is a flowchart illustrating the operation of the control section in the second embodiment;

FIG. 7 is a schematic diagram of a modified configuration of the receiving terminal in the first embodiment;

FIG. 8 is a schematic diagram of a modified configuration of the receiving terminal according to the second embodiment;

FIG. 9 is a schematic diagram of a modified configuration of the conditional-access module according to the first embodiment; and

FIG. 10 is a schematic diagram of a modified configuration of the conditional-access module according to the second embodiment.

### DETAILED DESCRIPTION OF THE INVENTION

Embodiments of the present invention will be described with reference to the accompanying drawings.

(First Embodiment)

FIG. 1 is a schematic diagram showing the configuration of a receiving terminal to which a conditional-access module according to a first embodiment of the present invention is connected. The receiving terminal 10 includes a receiving section 11, a conditional access information separation section 12, a conditional-access module input/output section 13, a descramble section 14, a playback section 15, and a control section 16 and is adapted to allow the conditional-access module 20 to be removably attached thereto.

The receiving section 11 has a function of, when receiving a received signal from an antenna (not shown) or a cable television signal, producing a transport stream from the input signal and sending it to the conditional access information separation section 12.

The conditional access information separation section 12 has a function of separating the transport stream from the receiving section 11 into conditional access information and program content and then sending the conditional access information and the program content to the conditional-access module input/output section 13 and the descramble section 14, respectively.

Here, the conditional access information, which is in encrypted form, includes a scramble key for descrambling program content, contract information for allowing the scramble key to be used, and a digital signature generated by the contract information.

When the conditional-access module 20 is attached to the receiving terminal 10, the conditional-access module input/output section 13 has a function of sending the conditional access information received from the conditional access information separation section 12 to the conditional-access module 20 and a function of sending the scramble key received from the conditional-access module 20 to the descramble section 14.

The descramble section 14 has a function of descrambling scrambled program content contained in program content from the conditional access information separation section 12 using the scramble key received from the conditional-access module input/output section 13 and then sending the descrambled program content to the playback section 15.

When unscrambled program content is contained in program content sent from the conditional access information separation section 12, the descramble section 14 also has a function of sending it to the playback section 15 as it is.

The playback section 15 has a function of playing sound and video information from program content sent from the descramble section 14.

The control section 16 controls the operation of each of the sections 11 to 15. For example, the control section 16 has a function of switching channels and a function of controlling the timing of data transfer.

The conditional-access module 20, which is removably attached to the receiving terminal 10, has an input/output section 21, a memory 22, a conditional access information decrypting section 23, a multiple-length integer operations section 24 and a control section 25 interconnected by a bus. The input/output section 21 and the control section 25 are connected with each other through a control switching section 26. In order to allow for ease of attachment to and removal from the receiving terminal 10, the conditional-access module 20 should preferably be implemented in a small size device such as a smart card.

The input/output section 21 has a function of, when receiving conditional access information from the conditional-access input/output section 13 in the receiving terminal 10, notifying the control switching section 26 of reception of the conditional access information, a function of writing the conditional access information into the memory 22, and a function of sending a scramble key received from the control section 25 to the conditional-access module input/output section 13.

The memory 22, which can be read from or written to by each of the sections 21 and 23 to 26, has a conditional access information decrypting key, contract information of the corresponding terminal 10, the conditional access information, etc., temporarily stored in it.

The conditional access information decrypting section 23, controlled through real-time processing by the control section 25, has a function of decrypting the conditional access information in the memory 22 and sending the decrypted conditional access information to the control section 25.

The multiple-length integer operations section 24, controlled through background processing by the control section 25, has a function of performing multiplelength integer operations required to verify the digital signature and sending the results to the control section 25.

The control section 25 has a function of carrying out real-time processing or background processing under the control of the control switching section 26 and a function of controlling each of the sections 21 to 24 and 26 according to the real-time processing or background processing in execution.

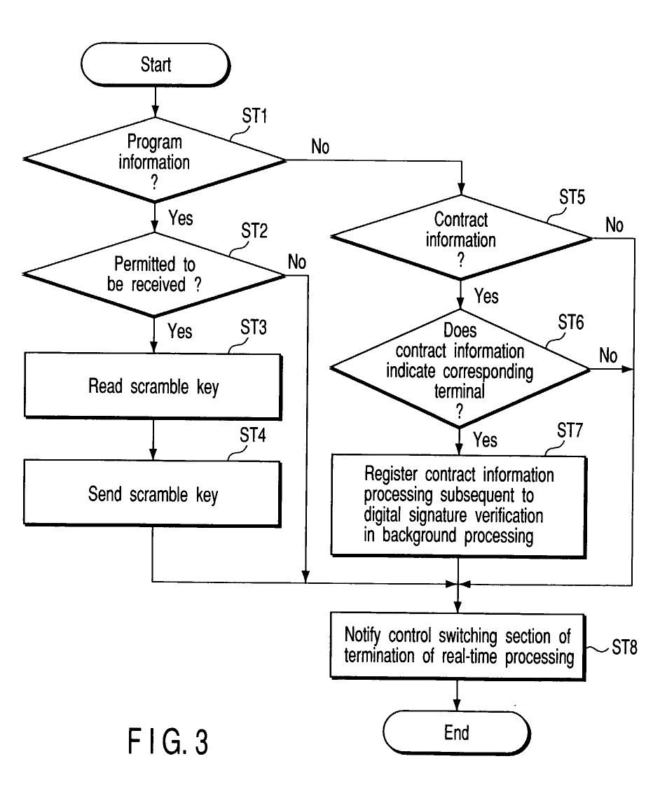

Here, the real-time processing includes, in addition to usual decrypting/analysis processes of causing the conditional access information decrypting section 24 to decrypt the conditional access information and sending the scramble key for allowing contract services to be received to the input/output section 21 on the basis of the decrypted conditional access information, a process of registering the content of the background processing and a process of switching from the real-time processing to the background processing as indicated in part of the flowchart of FIG. 3.

The background processing involves a process of verifying the digital signature by controlling the multiple-length integer operations section 24, a process of disabling program content from being viewed when forgery or alteration of the conditional access information is detected through verification of the digital signature, and a process based on contract information after the validity of the conditional access information has been confirmed through the signature verification.

The control switching section 26 has a function of switching the control section 25 from the background processing to the real-time processing when the conditional access information is entered into the input/output section 21 and a function of switching the control section 25 from the real-time processing to the background processing upon receipt from the control section 25 of notification of the termination of the real-time processing.

Next, the operation of the receiving terminal and the conditional-access module thus configured will be described.

First, in the receiving terminal 10, the receiving section 11, when receiving a signal from the antenna (not shown) or a cable television signal, produces a transport stream from the input signal and sends it to the conditional access information separation section 12.

The conditional access information separation section 12 separates the received transport stream into conditional access information and program content and then sends the conditional access information and the program content to the conditional-access module input/output section 13 and the descramble section 14, respectively.

The conditional-access module input/output section 13 sends the conditional access information received from the conditional access information separation section 12 to the conditional-access module 20 and then sends the scramble key received from the conditional-access module 20 to the descramble section 14.

The descramble section 14 descrambles scrambled program content contained in the program content sent from the conditional access information separation section 12 using the scramble key received from the conditional-access module input/output section 13 and then sends the descrambled program content to the playback section 15.

The playback section 15 plays sound and video information from the program content sent from the descramble section 14.

The operation of the receiving terminal 10 described so far remains unchanged from that of the conventional receiving terminal. However, the embodiments of the present invention differs from the prior art in that the conditional access information contains a digital signature and the conditional-access module 20 is adapted to verify the digital signature. This will be described below.

It is assumed here that the conditional access information is entered from the receiving terminal 10 into the input/output section 21 when the control section 25 in the conditional-access module 20 is executing the background processing.

Then, the control switching section 26 stops the background processing in the control section 25 and saves the state of the control section 25. After that, the control switching section 26 causes the control section 25 to initiate the real-time processing of the conditional access information.

The control section 25 causes the conditional access information decrypting section 24 to decrypt the conditional access information. Based on the decrypted conditional access information, the control section makes a decision of whether or not the conditional access information is program information (step ST1). If so, then the control section 25 makes a decision of whether or not the program information is permitted to be received (step ST2).

When, as a result of step ST2, it is not permitted to be received, the control section 25 terminates the real-time processing. When it is permitted to be received, on the other hand, the control section 25 reads the scramble key (step ST3) and sends it to the conditional-access module input/output section 13 in the receiving terminal 10 (step ST4), thereby terminating the real-time processing.

When the conditional access information is not program information in step ST1, a decision is made as to whether or not it is contract information (step ST5). If it is not, the real-time processing is terminated. If, on the other hand, it is contract information, then a decision is made as to whether or not the contract information indicates the corresponding terminal 10 (step ST6).

If, as a result of step ST6, it does, contract information processing subsequent to digital signature verification is registered in the background processing (step ST7) and then the real-time processing is terminated; otherwise, the real-time processing is immediately terminated.

When the real-time processing is terminated as a result of each of steps ST2 and ST4 to ST7, the control section 25 notifies the control switching section 26 of the termination of the real-time processing (step ST8).

When notified of the termination of the real-time processing, the control switching section 26 returns the control section 25 to the state of background processing, causing the control section to resume the background processing.

Then, the control section 25 causes the multiple-length integer operations section 24 to verify the digital signature. This verification processing need not be completed in a single background process; even if an interruption has occurred, it can be carried out in the subsequent background process. If the digital signature is determined to be true, the control section 25 writes the contract information in the memory 22. On the other hand, if the digital signature is determined to be false, the control section 25 rejects the contract information.

After the verification of the digital signature, the control section 25 performs processing, such as confirmation of the term of validity, based on the contract information in the background.

As described above, according to the first embodiment, a digital signature generated by conditional access information can be verified in the background by the control section 25 and the control switching section 26, thus allowing conditional access information to be verified while descrambling scrambled contents in real-time without any waiting time in viewing digital broadcasting, and the security of the conditional access information to be improved.

(Second Embodiment)

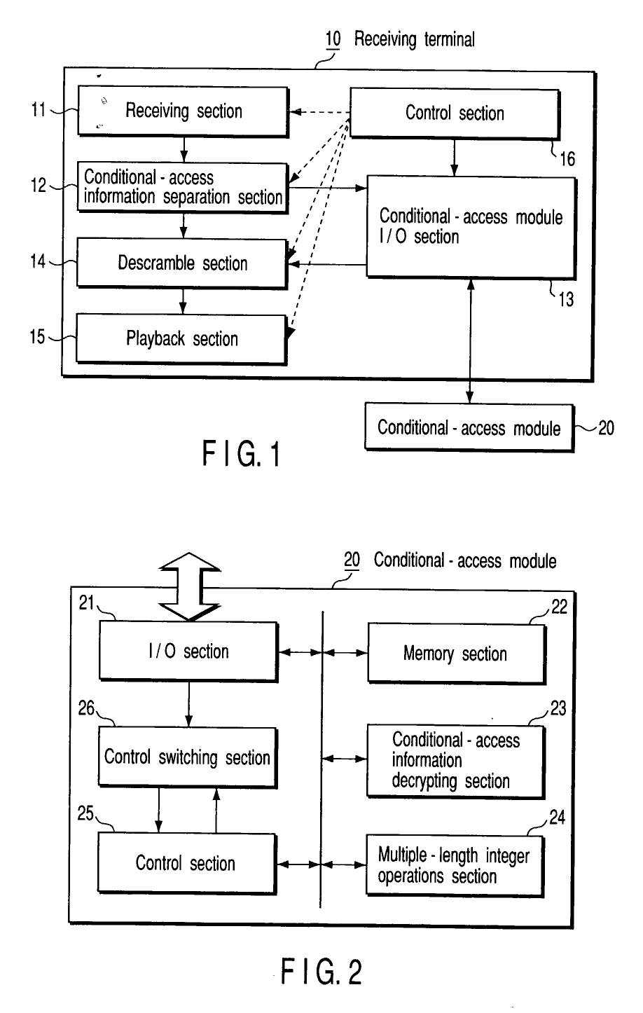

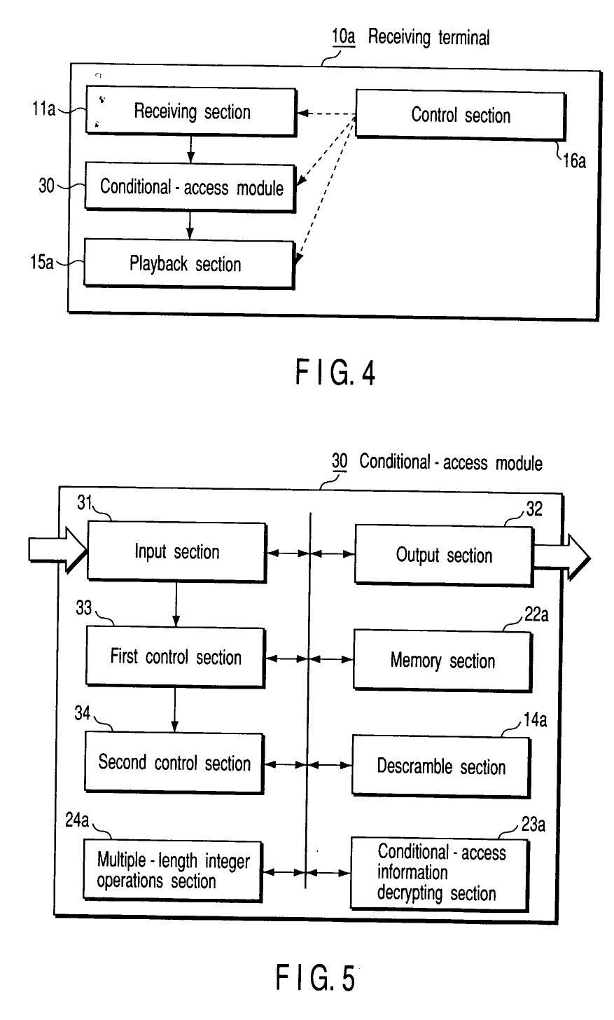

FIG. 4 is a schematic diagram showing the configuration of a receiving terminal according to a second embodiment of the present invention. In FIG. 4, parts substantially identical to those in FIGS. 1 and 2 are designated by like reference numerals having an alphabetic character affixed and detailed descriptions thereof are omitted. Here, only different portions will be described. Substantially identical parts are those that are identical in basic internal processing but different in locations from and to which data is input and output.

The receiving terminal 10a of the second embodiment, as shown in FIG. 4, has the parts 12, 13 and 14 in the first embodiment omitted and a conditional-access module 30 incorporated between the receiving section 11a and the playback section 15a.

The conditional-access module 30 has the program content descramble function incorporated. Specifically, as shown in FIG. 5, an input section 31, an output section 32, a first control section 33, a second control section 34, a descramble section 14a, a memory 22a, a conditional access information decrypting section 23a and a multiple-length integer operations section 24a are interconnected by a bus.

The input section 31 has a function of separating the transport stream from the receiving section 11a in the receiving terminal 10a into conditional access information and program content and then sending the conditional access information and the program content to the first control section 33 and the descramble section 14a, respectively.

The output section 32 has a function of sending the descrambled program content from the descramble section 14a (or originally unscrambled program content) to the playback section 15a in the receiving terminal 10a.

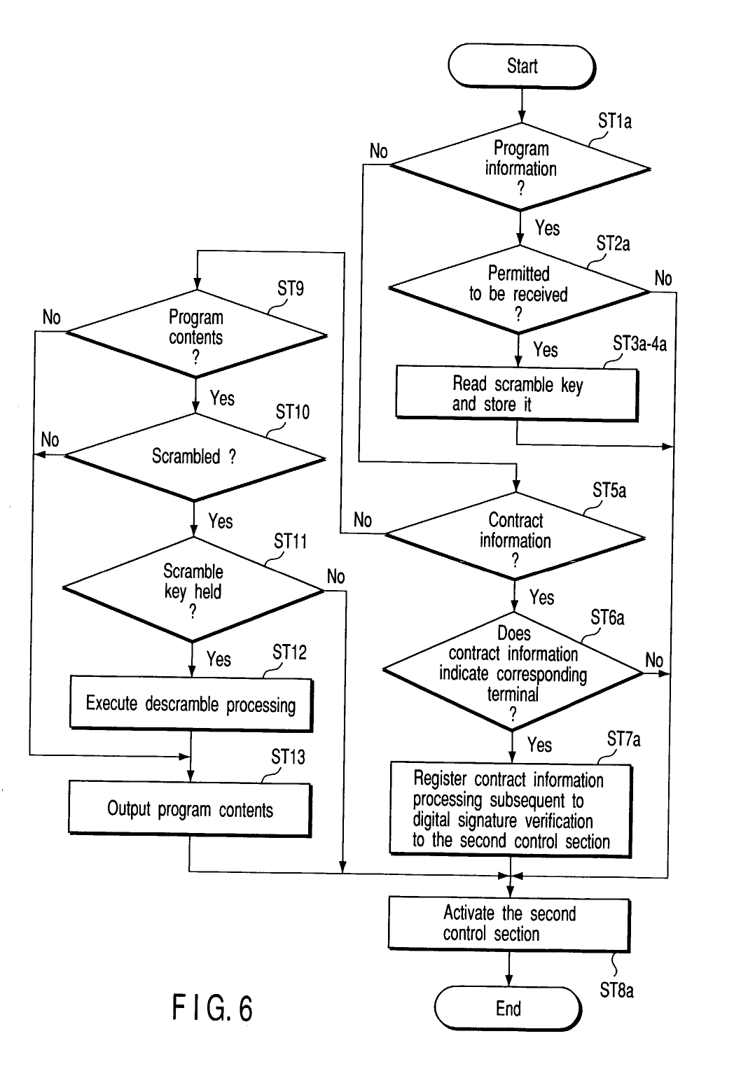

The first control section 33 is activated by the conditional access information received from the input section 31 to perform the real-time processing as shown in FIG. 6.

The second control section 34 is activated by notification from the first control section 33 to perform the background processing.

Next, the operation of the receiving terminal and the conditional-access module thus configured will be described.

First, in the receiving terminal 10a, the receiving section 11a produces a transport stream from an input signal thereto and sends it to the conditional-access module 30.

In the conditional-access module 30, the input section 31 separates the received transport stream into conditional access information and program content and then sends the conditional access information and the program content to the first control section 33 and the descramble section 14a, respectively.

The descramble section 14 descrambles scrambled program content contained in the program content using the scramble key received from the first control section 33 and then sends the descrambled program content to the output section 32.

The output section 32 sends the program content to the playback section 15a. The playback section 15a plays sound and video information from the received program content.

The receiving terminal 10a remains unchanged in operation from the combination of the receiving terminal 10 and the conditional-access module 20 in the first embodiment. The second embodiment differs from the first embodiment in that the built-in conditional-access module 30 has the two control sections 33 and 34 and the real-time processing by the first control section 33 and the background processing by the second control section 34 are switched. This will be described next.

It is assumed that the conditional access information is entered from the input section 31 into the first control section while the second control section 34 is carrying out the background processing.

Then, the first control section 33 stops the background processing by the second control section 34 and then starts the real-time processing of the conditional access information.

That is, the first control section 33 carries out steps STla to ST7a corresponding to steps ST1 to ST7 in the first embodiment. However, when the conditional access information is not contract information in step ST5a, without terminating the real-time processing a decision is made as to whether or not the conditional access information is program content (step ST9).

If not program content in step ST9, the procedure goes-to step ST13 to output the conditional access information from the output section 32. If, on the other hand, the conditional access information is program content, a decision is made as to whether or not it is scrambled (step ST10).

If not scrambled in step ST11, the procedure goes to step ST13 to output the conditional access information from the output section 32. If, on the other hand, the conditional access information is scrambled, a decision is made as to whether or not the descramble key is held (step ST11).

When the decision in step ST11 is that the descramble key is not held, the real-time processing is terminated. If, on the other hand, the scramble key is held, it is sent to the descramble section 14a, so that the program content is descrambled (step ST12). The resulting program content is then output from the output section (step ST13), thus terminating the real-time processing.

At the termination of the real-time processing as a result of each of steps ST2a, ST3a-4a, ST6a, ST7a, ST11 and ST13, the first control section 33 activates the second control section 34 (step ST8a).

When activated by the first control section 33, the second control section 34 resumes the background processing. In the background processing, as in the first embodiment, the second control section verifies the digital signature and then performs processing based on the contract information.

As described above, according to the second embodiment, a digital signature generated by conditional access information can be verified in the background by the first and second control sections 33 and 34, thus achieving the same advantages as the first embodiment.

The first control section 33 is simply required to perform the real-time processing, whereas the second control section 34 is merely required to carry out the background processing. Therefore, in the second embodiment, unlike the first embodiment, each of the first and second control sections 33 and 34 can be realized as a specialized configuration for the real-time processing and background processing, respectively.

The method described in each of the embodiments can be implemented and distributed in the form of a computer-executable program stored on a storage medium, such as a magnetic disk (floppy disk or hard disk), an optical disk (CD-ROM or DVD), a magneto-optical disk, or a semiconductor memory.

The storage medium may take any storage form as long as it can store a program and can be read and understood by a computer.

In addition, part of the processes in each of the embodiments may be carried out by an operating system or middleware, such as database management software or network software, which is running on a computer as instructed by a program installed from a storage medium into the computer.

Furthermore, the storage medium used in the present invention includes a storage medium containing a program downloaded over a LAN or the Internet.

Moreover, the storage medium is not limited in number to one. The processing in the embodiments may be performed through two or more media. The medium configuration need not to restricted.

The computer in the invention, which carries out processes in the embodiments based on a program stored on a storage medium, may be a single device, such as a personal computer, or a system in which two or more devices are networked together.

The computer in the invention includes not only a personal computer but also a processing unit or microcomputer contained in an information processing unit and names generically a device or equipment that can implement the inventive processing through a program.

The present invention may be practiced or embodied in still other ways without departing from the scope and spirit thereof.

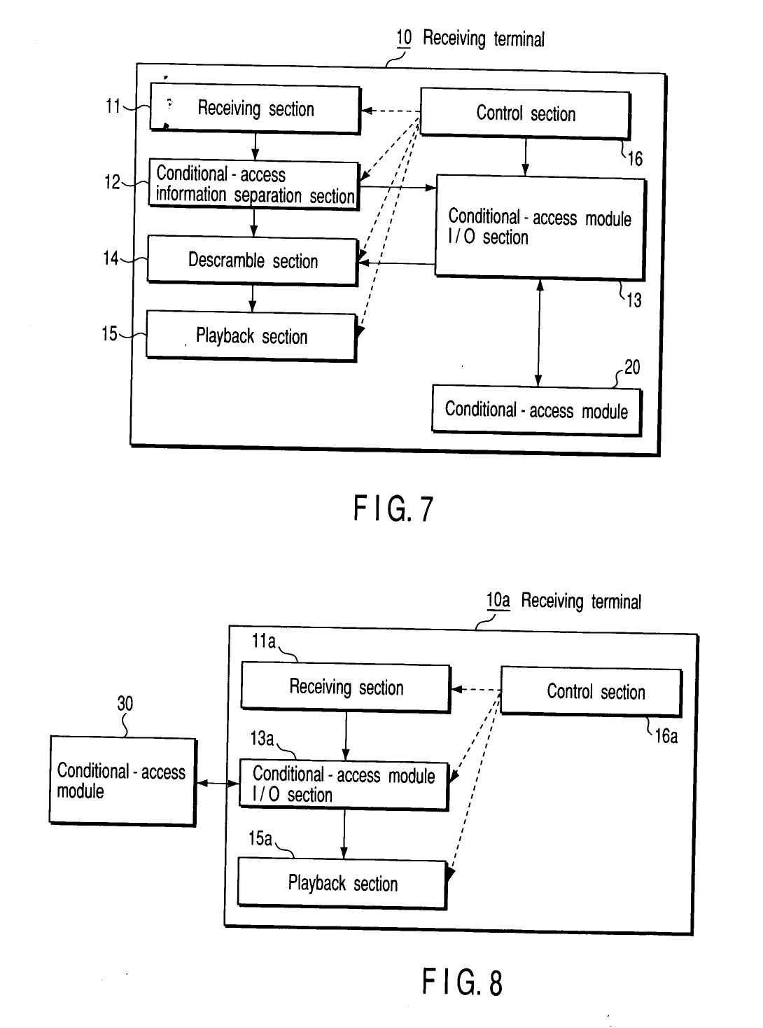

For example, the first embodiment may be modified such-that the conditional-access module 20 is incorporated into the receiving terminal 10 as shown in FIG. 7. In contrast to this, the second embodiment may be modified such that the conditional-access module 30 is attached to the receiving terminal 10a as shown in FIG. 8.

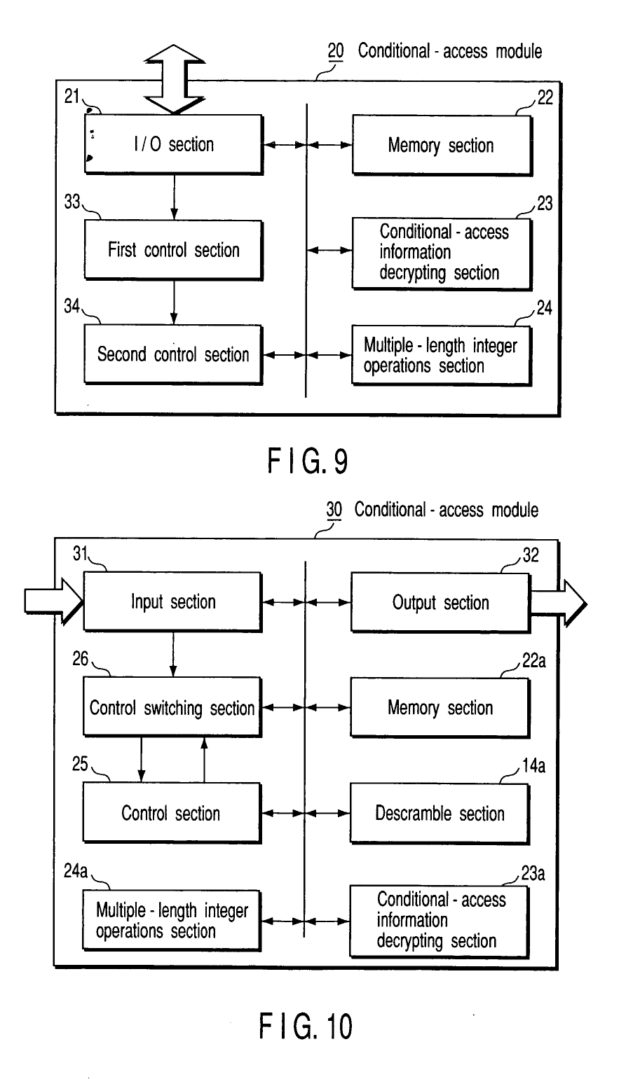

Moreover, in the first embodiment, the control section 25 and the control switching section 26 may be replaced by first and second control sections 33 and 34 as shown in FIG. 9. Likewise, in the second embodiment, the first and second control sections 33 and 34 may be replaced by the control section 25 and the control switching section 26 as shown in FIG. 10.

Furthermore, in the first embodiment, the order in which steps ST1 and ST5 are carried out may be reversed. When step ST5 is performed prior to step ST1, steps ST5 to ST7 associated with contract information will be performed on a preferential basis over steps ST1 to ST4 associated with program information.

Likewise, in the second embodiment, steps ST1a, ST5a and ST9 may be performed in any order. For example, when the steps are performed in the order of ST5a, ST1 and ST9, steps ST5a to ST7a associated with contract information, steps ST1a to ST4a associated with program information and steps ST9 to ST13 associated with program content will be carried out in this order.

The embodiments may be combined as much as possible. In this case, the advantages of the respective embodiments will be obtained in combination.

It should be noted that the embodiments contain inventions of various stages, and the structural elements of the inventions can be modified to derive other inventions. If an invention is derived by omitting some structural elements from the embodiments, the omitted structural elements can be compensated for with known technology when the derived invention is reduced to practice.

Lastly, the present invention can be modified in various manners without departing from the spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus of conditional-access module which is built in or attached to a receiving terminal apparatus for receiving digital broadcast signal containing scrambled program contents and encrypted conditional access information which includes a digital signature generated by part thereof and is used to descramble the program contents under contract, comprising:
control means for executing a real-time processing for decrypting/analyzing the conditional access information or a background processing for verifying the digital signature; and
control switching means for causing the control means to execute the real-time processing in preference to the background processing and, at the termination of the real-time processing, switching the control means from the real-time processing to the background processing.

2. A receiving terminal apparatus for receiving digital broadcast signal containing scrambled program contents and encrypted conditional access information which includes a digital signature generated by part thereof and is used to descramble the program contents under contract, comprising:
an apparatus of conditional-access module build in, including,
control means for executing a real-time processing for decrypting/analyzing the conditional access information or a background processing for verifying the digital signature, and
control switching means for causing the control means to execute the real-time processing in preference to the background processing and, at the termination of the real-time processing, switching the control means from the real-time processing to the background processing.

3. An apparatus of conditional-access module which is built in or attached to a receiving terminal apparatus for receiving scrambled program contents and encrypted conditional access information which includes a scramble key for descrambling the program contents, contract information for allowing the scramble key to be used, and a digital signature generated by the contract information and descrambling the program contents using the scramble key, said apparatus of conditional-access module for controlling the descrambling of the program contents on the basis of the decrypted contract information comprising:
a memory unit configured to store the contract information for descrambling of the program contents;
a control unit configured to execute a real-time processing or a background processing, the real-time processing which includes decrypting the conditional access information inputted from the receiving terminal apparatus, confirming its own contract on the basis of the decrypted contract information, and outputting the decrypted scramble key to the receiving terminal apparatus, and the background processing which includes verifying decrypted own contract information on the basis of the decrypted digital signature, when the result of verification indicates truly, writing the decrypted own contract information in the memory unit and, when the result of verification indicates falsely, rejecting the decrypted own contract information; and
a control switching unit configured to cause the control unit to execute the real-time processing in preference to the background processing and, at the termination of the real-time processing, switching the control unit from the real-time processing to the background processing.

4. A receiving terminal apparatus comprising:
a receiving unit configured to receive scrambled program contents and encrypted conditional access information which includes a scramble key for descrambling the program contents, contract information for allowing the scramble key to be used, and a digital signature generated by the contract information;
a separating unit configured to separate the program contents and the conditional access information, when the program contents and the conditional access information are inputted from the receiving unit;
an apparatus of conditional-access module built in for controlling the descrambling of the program contents on the basis of the decrypted contract information, said apparatus of conditional-access module including,
a memory unit configured to store the contract information for descrambling of the program contents,
a control unit configured to execute a real-time processing or a background processing, the real-time processing which includes decrypting the conditional access information separated by the separating unit, confirming its own contract on the basis of the decrypted contract information, and outputting the decrypted scramble key, and the background processing which includes verifying the decrypted own contract information on the basis of the decrypted digital signature and, when the result of verification indicates truly, writing the decrypted own contract information in the memory unit and, when the result of verification indicates falsely, rejecting the decrypted own contract information, and
a control switching unit configured to cause the control unit to execute the real-time processing in preference to the background processing and, at the termination of the real-time processing, switching the control unit from the real-time processing to the background processing; and
a descrambling unit configured to descramble the program contents inputted from the separating unit using the scramble key inputted from the control unit.

5. An apparatus of conditional-access module which is built in or attached to a receiving terminal apparatus for receiving digital broadcast signal containing scrambled program contents and encrypted conditional access information which includes a digital signature generated by part thereof and is used to descramble the program contents under contract, comprising:
first control means for executing the real-time processing for decrypting/analyzing the conditional access information; and
second control means for, after the termination of the real-time processing by the first control means, executing the background processing including verifying the digital signature.

6. A receiving terminal apparatus for receiving digital broadcast signal containing scrambled program contents and encrypted conditional access information which includes a digital signature generated by part thereof and is used to descramble the program contents under contract, comprising:
an apparatus of conditional-access module built in, including,
first control means for executing a real-time processing for decrypting/analyzing the conditional access information, and
second control means for executing a background processing including verifying the digital signature after the termination of the real-time processing by the first control means.

7. An apparatus of conditional-access module which is built in or attached to a receiving terminal apparatus for receiving scrambled program contents and encrypted conditional access information which includes a scramble key for descrambling the program contents, contract information for allowing the scramble key to be used, and a digital signature generated by the contract information and descrambling the program contents using the scramble key, said apparatus of conditional-access module for controlling the descrambling of the program contents on the basis of the decrypted contract information comprising:
a memory unit configured to store the contract information for descrambling of the program contents;
a first control unit configured to execute a real-time processing of decrypting the conditional access information inputted from the receiving terminal apparatus, confirming its own contract on the basis of the decrypted contract information, and outputting the decrypted scramble key to the receiving terminal apparatus; and
a second control unit configured to execute a background processing of verifying decrypted own contract information on the basis of the digital signature after the termination of the real-time processing by the first control unit, when the result of verification indicates truly, writing the decrypted own contract information in the memory unit and, when the result of verification indicates falsely, rejecting the decrypted own contract information.

8. A receiving terminal apparatus comprising:
a receiving unit configured to receive scrambled program contents and encrypted conditional access information which includes a scramble key for descrambling the program contents, contract information for allowing the scramble key to be used, and a digital signature generated by the contract information;
an apparatus of conditional-access module built in for controlling the descrambling of the program contents on the basis of decrypted contract information, said apparatus of conditional-access module including,
a memory unit configured to store the contract information for descrambling of the program contents;
a first control unit configured to execute a real-time processing of decrypting the conditional access information inputted from the receiving unit, confirming its own contract on the basis of the decrypted contract information, and outputting the decrypted scramble key, and
a second control unit configured to execute a background processing of verifying decrypted own contract information on the basis of the decrypted digital signature after the termination of the real-time processing by the first control unit, when the result of verification indicates truly, writing the decrypted own contract information in the memory unit and, when the result of verification indicates falsely, rejecting the decrypted own contract information; and
a descrambling unit configured to descramble the program contents inputted from the receiving unit using the scramble key inputted from the first control unit.

9. A method of conditional-access for receiving scrambled program contents and encrypted conditional access information which includes a scramble key for descrambling the program contents, contract information for allowing the scramble key to be used, and a digital signature generated by the contract information and descrambling the program contents using the scramble key on the basis of the contract information and the digital signature, the method comprising:
executing a real-time processing or a background processing, the real-time processing which includes decrypting the conditional access information inputted from the receiving terminal apparatus, confirming the decrypted contract information, and obtaining the scramble key and the digital signature, and the background processing which includes verifying the digital signature in the background; and
executing the real-time processing in preference to the background processing and, at the termination of the real-time processing, switching the processing from the real-time processing to the background processing.

10. A method of conditional-access for receiving scrambled program contents and encrypted conditional access information which includes a scramble key for decrypting the program contents, contract information for allowing the scramble key to be used, and a digital signature generated by the contract information and descrambling the program contents using the scramble key on the basis of the contract information and the digital signature, the method comprising:
executing a real-time processing of decrypting the conditional access information inputted from the receiving terminal apparatus, confirming the decrypted contract information, and obtaining the scramble key and the digital signature; and
executing a background processing including verifying the digital signature after the termination of the real-time processing.
